(19) United States
(12) Patent Application Publication
(10) Pub. No.: US 2025/0310649 A1
(43) Pub. Date: Oct. 2, 2025

(54) IMAGE PROCESSING APPARATUS, AND IMAGE PROCESSING METHOD

(71) Applicant: CANON KABUSHIKI KAISHA, Tokyo (JP)

(72) Inventor: NOBUTO MATSUDA, Tokyo (JP)

(21) Appl. No.: 19/082,736

(22) Filed: Mar. 18, 2025

(30) Foreign Application Priority Data
Mar. 29, 2024 (JP) 2024-056439

(51) Int. Cl. H04N 23/70

(52) U.S. Cl. CPC H04N 23/70

(57) ABSTRACT

An image processing apparatus according to the present invention includes a processor, and a memory storing a program which, when executed by the processor, causes the image processing apparatus to execute first acquisition processing of acquiring optical characteristic information regarding an optical characteristic of a lens, execute second acquisition processing of acquiring a moving image including images of a plurality of frames acquired via the lens, execute first processing of performing image processing on an image of each frame of the moving image on a basis of the optical characteristic information, and execute output processing of outputting an image after the image processing, the optical characteristic information corresponding to the image, and image processing information regarding the image processing corresponding to the image in association with each other.

### BACKGROUND OF THE INVENTION

### Field of the Invention

The present invention relates to an image processing apparatus, and particularly to technology for correcting a moving image on the basis of an optical characteristic of a lens.

### Description of the Related Art

Image quality degradation caused by an optical characteristic of a lens occurs in an image obtained by an imaging apparatus. For example, peripheral light falloff, distortion aberration, chromatic aberration of magnification, and the like occur. Such image quality degradation can be reduced by image processing (optical correction processing) based on the optical characteristic of the lens, and is reduced (corrected) by the imaging apparatus or reduced in a subsequent process using an apparatus different from the imaging apparatus.

Since the optical characteristic changes depending on a focal distance, a photographing distance, a diaphragm value, and the like, it is necessary to use the optical characteristic at the time of imaging in order to suitably perform optical correction processing (in order to reduce image quality degradation caused by the optical characteristic of the lens without excess or deficiency by the optical correction processing). JP 2014-23063 A discloses a lens interchangeable imaging apparatus that records a captured image and correction data used for optical correction processing in association with each other.

However, in the related art, although the optical correction processing can be suitably performed on the moving image on which the optical correction processing has not been previously performed, the optical correction processing cannot be suitably performed on the moving image on which the unique optical correction processing has already been performed by an imaging apparatus. The phrase “to suitably perform the optical correction processing” means to reduce image quality degradation caused by the optical characteristic of the lens without excess or deficiency by the optical correction processing.

### SUMMARY OF THE INVENTION

The present invention provides technology capable of suitably performing optical correction processing on a moving image regardless of whether or not the optical correction processing has already been performed.

The present invention in its first aspect provides an image processing apparatus including a processor, and a memory storing a program which, when executed by the processor, causes the image processing apparatus to execute first acquisition processing of acquiring optical characteristic information regarding an optical characteristic of a lens, execute second acquisition processing of acquiring a moving image including images of a plurality of frames acquired via the lens, execute first processing of performing first image processing on an image of each frame of the moving image on a basis of the optical characteristic information, and execute output processing of outputting an image after the first image processing, the optical characteristic information corresponding to the image, and first image processing information regarding the first image processing corresponding to the image in association with each other.

The present invention in its second aspect provides an image processing apparatus including a processor, and a memory storing a program which, when executed by the processor, causes the image processing apparatus to execute acquisition processing of acquiring, for each frame of a moving image, an image after first image processing based on an optical characteristic of a lens, optical characteristic information regarding the optical characteristic, and first image processing information regarding the first image processing, and execute reprocessing processing of cancelling the first image processing performed on the image on a basis of the first image processing information, and performing second image processing on an image after the cancellation on a basis of the optical characteristic information.

The present invention in its third aspect provides an image processing method including acquiring optical characteristic information regarding an optical characteristic of a lens, acquiring a moving image including images of a plurality of frames acquired via the lens, performing image processing on an image of each frame of the moving image on a basis of the optical characteristic information, and outputting an image after the image processing, the optical characteristic information corresponding to the image, and image processing information regarding the image processing corresponding to the image in association with each other.

The present invention in its fourth aspect provides an image processing method including acquiring, for each frame of a moving image, an image after first image processing based on an optical characteristic of a lens, optical characteristic information regarding the optical characteristic, and first image processing information regarding the first image processing, and cancelling the first image processing performed on the image on a basis of the first image processing information, and perform second image processing on an image after the cancellation on a basis of the optical characteristic information.

The present invention in its fifth aspect provides a non-transitory computer readable medium that stores a program, wherein the program causes a computer to execute an image processing method including acquiring optical characteristic information regarding an optical characteristic of a lens, acquiring a moving image including images of a plurality of frames acquired via the lens, performing image processing on an image of each frame of the moving image on a basis of the optical characteristic information, and outputting an image after the image processing, the optical characteristic information corresponding to the image, and image processing information regarding the image processing corresponding to the image in association with each other. The present invention in its sixth aspect provides a non-transitory computer readable medium that stores a program, wherein the program causes a computer to execute an image processing method including acquiring, for each frame of a moving image, an image after first image processing based on an optical characteristic of a lens, optical characteristic information regarding the optical characteristic, and first image processing information regarding the first image processing, and cancelling the first image processing performed on the image on a basis of the first image processing information, and perform second image processing on an image after the cancellation on a basis of the optical characteristic information.

Further features of the present invention will become apparent from the following description of embodiments with reference to the attached drawings.

### BRIEF DESCRIPTION OF THE DRAWINGS

FIG. 1 is a block diagram of an imaging apparatus according to a first embodiment;

FIG. 2 is a flowchart of a correction data determination unit according to the first embodiment;

FIG. 3 is a block diagram of an image processing system according to a second embodiment;

FIG. 4 is a schematic diagram of interpolation of optical characteristic information according to the second embodiment; and

FIG. 5 is a flowchart of an optical correction adjustment apparatus according to the second embodiment.

### DESCRIPTION OF THE EMBODIMENTS

Embodiments of the present invention will be described. Each of the embodiments of the present invention described below can be implemented solely or as a combination of a plurality of the embodiments or features thereof where necessary or where the combination of elements or features from individual embodiments in a single embodiment is beneficial.

In a case where optical correction processing (image processing for reducing image quality degradation caused by an optical characteristic of a lens on the basis of the optical characteristic) has been performed on a moving image by an imaging apparatus in real time, a timing at which an image is obtained by imaging is different from a timing at which correction data used for the optical correction processing is obtained. For this reason, excessive optical correction processing may be performed without using the optical characteristic of the lens at the time of imaging. Therefore, a correction amount of the optical correction processing may be limited or the correction amount may be changed with a predetermined time constant. The image quality degradation caused by the optical characteristic is, for example, peripheral light falloff, distortion aberration, or chromatic aberration of magnification.

However, in the above example, since the optical characteristic at the time of imaging is not used, the image quality degradation caused by the optical characteristic is not sufficiently reduced. Therefore, there is a need to adjust an image in a subsequent process using an apparatus different from the imaging apparatus.

In the subsequent process, the optical correction processing using the optical characteristic at the time of imaging can be performed by adjusting the difference in timing. However, in the related art, although the optical correction processing can be suitably performed on a moving image on which the optical correction processing has not been performed, the optical correction processing cannot be suitably performed on a moving image on which the optical correction processing has been performed by the imaging apparatus. This is because both information of optical correction performed by the imaging apparatus and the optical characteristic of the lens are required. The phrase “to suitably perform the optical correction processing” means to reduce image quality degradation caused by the optical characteristic of the lens without excess or deficiency by the optical correction processing.

Therefore, in the present embodiment, an image after optical correction processing (image after image processing), optical characteristic information corresponding to the image, and optical correction information corresponding to the image are used. The optical characteristic information corresponding to the image is information regarding an optical characteristic at the time of capturing the image, and indicates, for example, the optical characteristic. The optical correction information corresponding to the image is image processing information regarding the optical correction processing performed on the image, and indicates, for example, correction data (parameter) used for the optical correction processing. In this manner, the image before the optical correction processing can be restored from the image after the optical correction processing and the optical correction information corresponding to the image. Then, by performing optical correction processing (reprocessing) based on the optical characteristic information on the restored image, it is possible to obtain an image in which image quality degradation caused by the optical characteristic has been reduced without excess or deficiency.

### First Embodiment

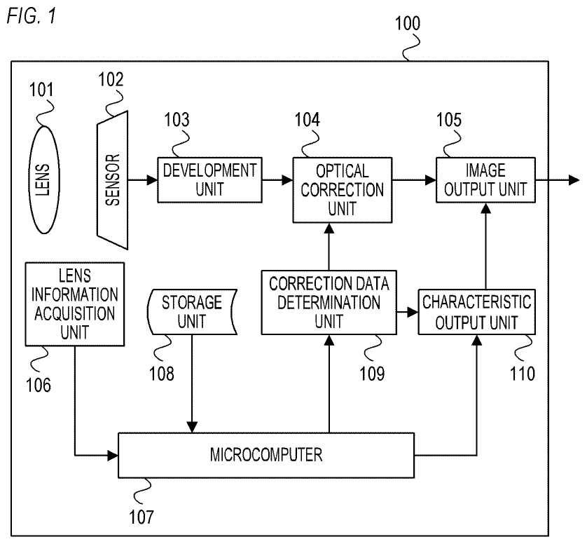

Hereinafter, a first embodiment of the present invention will be described. FIG. 1 is a block diagram illustrating a configuration of an imaging apparatus 100 which is an example of an image processing apparatus according to the first embodiment.

A lens 101 forms an optical image of an object on a sensor 102. The sensor 102 performs photoelectric conversion on the formed optical image to convert the optical image into RAW image data. A development unit 103 performs development processing on the RAW image data. As a result, image data after the development processing is obtained. In the first embodiment, moving image data (data of a moving image including images of a plurality of frames) is obtained. An optical correction unit 104 performs optical correction processing on an image of each frame of the moving image obtained by the development unit 103.

A microcomputer 107 controls the entire imaging apparatus 100.

A lens information acquisition unit 106 acquires lens information regarding a state of the lens 101. For example, the lens information acquisition unit 106 acquires lens information regarding an optical characteristic at the time of imaging (when an optical image is formed from the lens 101 to the sensor 102). The lens information includes information such as a focal distance, an object distance, and a diaphragm value.

The microcomputer 107 acquires optical characteristic information regarding the optical characteristic of the lens 101 on the basis of the lens information acquired by the lens information acquisition unit 106. The optical characteristic information indicates at least one of a characteristic of peripheral light falloff, a characteristic of chromatic aberration of magnification, and a characteristic of distortion aberration.

A method for acquiring the optical characteristic information is not particularly limited. For example, a plurality of pieces of optical characteristic information corresponding to a plurality of pieces of lens information are stored in advance in a storage unit 108, and the microcomputer 107 reads the optical characteristic information corresponding to the lens information acquired by the lens information acquisition unit 106 from the storage unit 108. When the optical characteristic information corresponding to the lens information acquired by the lens information acquisition unit 106 is not stored in the storage unit 108, the microcomputer 107 may read optical characteristic information corresponding to lens information closest to the lens information from the storage unit 108. The microcomputer 107 may acquire the optical characteristic information corresponding to the lens information acquired by the lens information acquisition unit 106 by reading a plurality of pieces of optical characteristic information from the storage unit 108 and performing interpolation processing using the plurality of pieces of optical characteristic information.

On the basis of the optical characteristic information acquired by the microcomputer 107, a correction data determination unit 109 determines correction data (correction characteristic) that is a parameter used for the optical correction processing. For example, the correction data determination unit 109 determines the correction data for each frame such that a change in the correction data between the frames of the moving image is limited. The correction data determination unit 109 may determine the correction data such that the correction data changes with a predetermined time constant. The correction data determination unit 109 may determine the correction data such that a change amount of the correction data between the frames of the moving image is limited to a threshold or less. According to these methods, it is possible to suppress the occurrence of a rapid change in the image due to a rapid change in the correction data and to suppress the occurrence of excessive optical correction processing due to the difference in the timing described above.

For example, a value of the correction data (correction value) may be determined by a predetermined ratio or difference from a target value (for example, a correction value for eliminating image quality degradation indicated by the optical characteristic information). If the target value is always used as the correction value, excessive optical correction processing easily occurs when the focal distance, the object distance, the diaphragm value, and the like are rapidly changed. If 80% of the target value is used as the correction value, excessive optical correction processing is less likely to occur even though the focal distance, the object distance, the diaphragm value, and the like are rapidly changed.

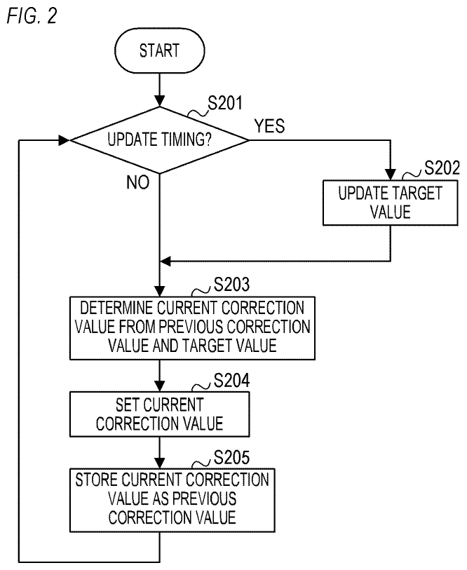

FIG. 2 is a flowchart illustrating processing of the correction data determination unit 109. The processing in FIG. 2 is performed, for example, for each frame of the moving image.

In step S201, the correction data determination unit 109 determines whether or not current timing is timing for updating the target value of the correction data. The target value is updated, for example, at predetermined time intervals for a plurality of frames. In a case where it is determined that the current timing is the update timing, the process proceeds to step S202, and otherwise, the process proceeds to step S204.

In step S202, the correction data determination unit 109 determines (updates) the target value according to the optical characteristic information acquired by the microcomputer 107. The target value is, for example, a correction value for eliminating image quality degradation indicated by the optical characteristic information.

In step S203, the correction data determination unit 109 determines a current correction value (correction value corresponding to a current frame) on the basis of a previous correction value (correction value determined for a previous frame of the current frame) and a current target value. For example, the correction data determination unit 109 determines, as the current correction value, a median value between the previous correction value and the current target value. In the first processing (first frame), the same value as the target value is determined as the correction value.

In step S204, the correction data determination unit 109 sets the current correction value determined in step S203 for the optical correction unit 104. The optical correction unit 104 performs optical correction processing using the set correction value.

In step S205, the correction data determination unit 109 stores the current correction value determined in step S203 as the previous correction value.

By performing the processing of FIG. 2 described above, it is possible to suppress the occurrence of a rapid change in the correction value. The update frequency of the target value, how the correction value approaches the target value, and the like are adjusted according to, for example, an allowable correction value change (change in the correction value).

The description returns to FIG. 1. An image (image data) after the optical correction processing, optical characteristic information corresponding to the image, and optical correction information (correction data) corresponding to the image are output by the image output unit 105 and a characteristic output unit 110 in association with each other. When the optical correction processing has not been performed, an image (image data) on which the optical correction processing has not been performed and optical characteristic information corresponding to the image are output in association with each other. The output is input to an external device or recorded in the storage unit 108, for example. The image output unit 105 outputs the image (image data) after the optical correction processing. The characteristic output unit 110 outputs optical characteristic information and optical correction information corresponding to the image output from the image output unit 105. The method of association is not particularly limited. For example, the image, the optical characteristic information, and the optical correction information may be stored in one file. Common metadata (identification information for association) may be added to each of the image, the optical characteristic information, and the optical correction information, and these may be output as separate files. The image, the optical characteristic information, and the optical correction information may be output by one system or may be output by a plurality of systems. For example, an output unit different from the output unit that outputs the image file may output another file including at least one of the optical characteristic information or the optical correction information after assigning the identification information for association similarly to the above.

Note that, although the example in which the present invention is applied to an imaging apparatus has been described, the image processing apparatus to which the present invention can be applied is not limited to the imaging apparatus. For example, the present invention may be applied to an image processing apparatus such as a personal computer, a smartphone, a tablet terminal, or the like connected to an imaging apparatus. In such a case, for example, the image processing apparatus acquires the image (image data) before the optical correction processing from the imaging apparatus, and acquires the optical characteristic information from the imaging apparatus or the lens (lens unit mounted on the imaging apparatus (interchangeable lens camera)). Then, the image processing apparatus performs optical correction processing on the basis of the acquired optical characteristic information. The optical correction information is acquired in the process of performing the optical correction processing. Thereafter, the image processing apparatus outputs an image (image data) after the optical correction processing, optical characteristic information corresponding to the image, and optical correction information corresponding to the image in association with each other.

### Second Embodiment

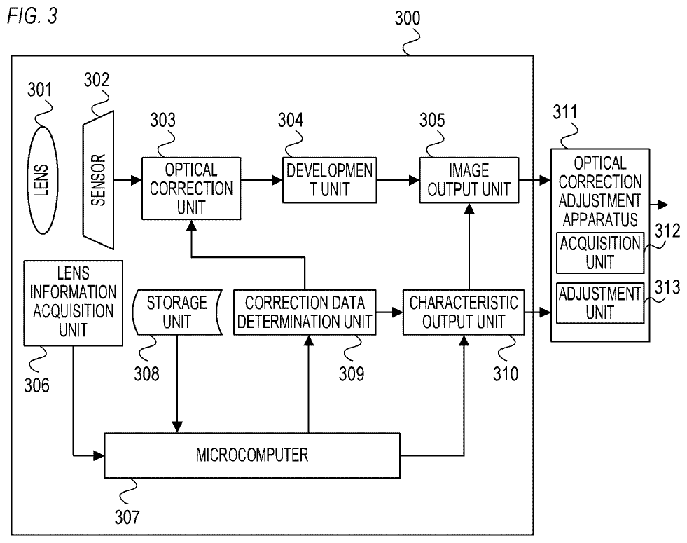

Hereinafter, a second embodiment of the present invention will be described. FIG. 3 is a block diagram illustrating a configuration of an image processing system according to the second embodiment. The image processing system in FIG. 3 includes an imaging apparatus 300 and an optical correction adjustment apparatus 311.

The imaging apparatus 300 will be described. A lens 301 forms an optical image of an object on a sensor 302. The sensor 302 performs photoelectric conversion on the formed optical image to convert the optical image into RAW image data. An optical correction unit 303 performs optical correction processing on the RAW image data obtained by the sensor 302. A development unit 304 performs development processing on the RAW image data after the optical correction processing. As a result, image data after the development processing is obtained. In the second embodiment, moving image data (data of a moving image including images of a plurality of frames) is obtained. The development processing includes interpolation processing of the RAW image data, gamma conversion, and the like.

A microcomputer 307 controls the entire imaging apparatus 300.

A lens information acquisition unit 306 acquires lens information regarding a state of the lens 301. For example, the lens information acquisition unit 306 acquires lens information regarding an optical characteristic at the time of imaging (when an optical image is formed from the lens 301 to the sensor 302). The lens information includes information such as a focal distance, an object distance, and a diaphragm value.

The microcomputer 307 acquires optical characteristic information regarding an optical characteristic of the lens 301 on the basis of the lens information acquired by the lens information acquisition unit 306. The optical characteristic information indicates at least one of a characteristic of peripheral light falloff, a characteristic of chromatic aberration of magnification, and a characteristic of distortion aberration.

A method for acquiring the optical characteristic information is not particularly limited. For example, a plurality of pieces of optical characteristic information corresponding to a plurality of pieces of lens information are stored in advance in a storage unit 308, and the microcomputer 307 reads the optical characteristic information corresponding to the lens information acquired by the lens information acquisition unit 306 from the storage unit 308. When the optical characteristic information corresponding to the lens information acquired by the lens information acquisition unit 306 is not stored in the storage unit 308, the microcomputer 307 may read optical characteristic information corresponding to lens information closest to the lens information from the storage unit 308. The microcomputer 307 may acquire the optical characteristic information corresponding to the lens information acquired by the lens information acquisition unit 306 by reading a plurality of pieces of optical characteristic information from the storage unit 308 and performing interpolation processing using the plurality of pieces of optical characteristic information.

An example of acquiring optical characteristic information indicating the characteristic of the peripheral light falloff will be described. The characteristic of the peripheral light falloff is a characteristic in which a light amount (brightness) changes according to an image height h from the center (optical axis) of the lens 301. A characteristic value (for example, a light amount) of the peripheral light falloff corresponding to the image height h is represented as V(h), and a characteristic value V(h) corresponding to the focal distance z, the object distance f, and the diaphragm value i is represented as V(h)(z, f, i). Among a plurality of characteristic values V(h) stored in the storage unit 308, eight characteristic values V(h) corresponding to eight coordinates in the vicinity of the coordinates (z, f, i) obtained by combining the focal distance, the object distance, and the diaphragm value are represented as follows.

V(h)(z1,f1,i1)

V(h)(z2,f1,i1)

V(h)(z1,f2,i1)

V(h)(z2,f2,i1)

V(h)(z1,f1,i2)

V(h)(z2,f1,i2)

V(h)(z1,f2,i2)

V(h)(z2,f2,i3)

It is assumed that the focal distance z internally divides a range between the focal distance z1 and the focal distance z2 into nz: 1−nz, the object distance f internally divides a range between the object distance f1 and the object distance f2 into nf: 1−nf, and the diaphragm value i internally divides a range between the diaphragm value i1 and the diaphragm value i2 into ni: 1−ni. In addition, a value of a point that internally divides a space between a point A and a point B into n: 1−n is represented as Interp(A, B, n).

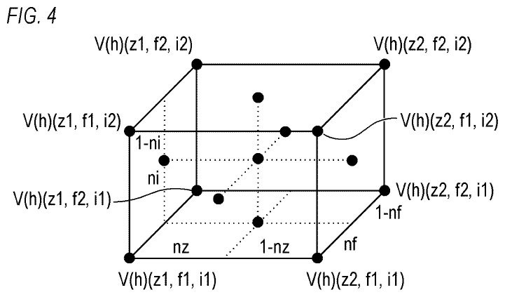

In this case, V(h)(z, f, i) can be calculated by the following Formula. FIG. 4 is a schematic diagram illustrating the following Formula.

```
V(h)(z,f,i)
=Interp[
    Interp{
      Interp(V(z1,f1,i1),V(z2,f1,i1),nz),
      Interp(V(z1,f2,i1),V(z2,f2,i1),nz),
    nf},
    Interp{
      Interp(V(z1,f1,i2),V(z2,f1,i2),nz),
      Interp(V(z1,f2,i2),V(z2,f2,i2),nz),
    nf},
  ni]
```

On the basis of the optical characteristic information acquired by the microcomputer 307, a correction data determination unit 309 determines correction data (correction characteristic) that is a parameter used for the optical correction processing.

An image (image data) after the optical correction processing and the gamma conversion, optical characteristic information corresponding to the image, optical correction information corresponding to the image, and gamma conversion information corresponding to the image are output by the image output unit 305 and a characteristic output unit 310 in association with each other. The image output unit 305 outputs the image (image data) after the optical correction processing and the gamma conversion. The characteristic output unit 310 outputs the optical characteristic information, the optical correction information, and the gamma conversion information corresponding to the image output from the image output unit 305. The gamma conversion information corresponding to the image is image processing information regarding gamma conversion performed on the image, and indicates, for example, a gamma characteristic (characteristic of gamma conversion). Note that image processing performed after the optical correction processing may not be the gamma conversion.

In the second embodiment, the gamma conversion is performed after the optical correction processing. Therefore, it is not possible to restore the image before the optical correction processing in the imaging apparatus 300 (the image on which neither the optical correction processing nor the gamma conversion has been performed) only from the image output from the imaging apparatus 300 and the optical correction information. Therefore, in the second embodiment, the gamma conversion information is also output from the imaging apparatus 300. As a result, it is possible to cancel the gamma conversion performed on the image from the image output from the imaging apparatus 300 and the gamma conversion information, and restore the image to an image on which the optical correction processing has been performed and the gamma conversion has not been performed. From the restored image before the gamma conversion and the optical correction information, it is possible to cancel the optical correction processing performed on the image, and restore the image to an image before the optical correction processing in the imaging apparatus 300 (the image on which neither the optical correction processing nor the gamma conversion has been performed). By performing optical correction processing (reprocessing) based on the optical characteristic information on the image after the cancellation, it is possible to obtain an image in which the image quality degradation caused by the optical characteristic has been reduced without excess or deficiency.

The optical correction adjustment apparatus 311 will be described. The optical correction adjustment apparatus 311 is an image processing apparatus that acquires an image output from the imaging apparatus 300 and information associated with the image, and adjusts optical correction processing performed on the image according to user's preference. The optical correction adjustment apparatus 311 is, for example, a personal computer, a smartphone, a tablet terminal, or the like. The optical correction adjustment apparatus 311 may be a part of the imaging apparatus 300.

An acquisition unit 312 acquires an image output from the imaging apparatus 300 and information associated with the image. An adjustment unit 313 adjusts the optical correction processing performed on the image acquired by the acquisition unit 312.

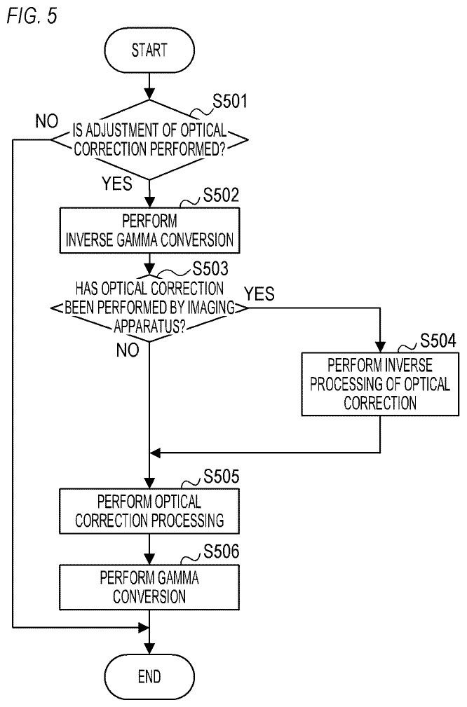

FIG. 5 is a flowchart illustrating processing of the optical correction adjustment apparatus 311. Here, it is assumed that the optical correction adjustment apparatus 311 has already acquired the image output from the imaging apparatus 300 and the information associated with the image, for each frame of the moving image.

In step S501, the adjustment unit 313 determines whether or not to perform adjustment of the optical correction processing. When the adjustment is performed, the process proceeds to step S502, and otherwise, the processing of FIG. 5 ends.

The processing in steps S502 to S506 is performed for each frame of the moving image.

In step S502, the adjustment unit 313 performs inverse conversion of the gamma conversion performed by the imaging apparatus 300 on the basis of the gamma conversion information associated with the target image that is the image of the frame to be processed. As a result, the gamma conversion performed on the target image is canceled.

In step S503, the adjustment unit 313 determines whether or not the optical correction processing has already been performed on the target image (by the imaging apparatus 300). When the optical correction processing has already been performed, the process proceeds to step S504, and otherwise, the process proceeds to step S505. The determination method is not particularly limited. A flag indicating whether or not the optical correction processing has been performed is associated with the target image, and whether or not the optical correction processing has been performed may be determined according to the flag. Whether or not the optical correction processing has been performed may be determined according to the presence or absence of the optical correction information associated with the target image.

In step S504, the adjustment unit 313 performs inverse processing of the optical correction processing performed by the imaging apparatus 300 on the basis of the optical correction information associated with the target image. As a result, the optical correction processing performed on the target image is canceled.

In step S505, the adjustment unit 313 performs optical correction processing (reprocessing) on the basis of the optical characteristic information associated with the target image. In a case where the optical correction processing has not already been performed on the target image by the imaging apparatus 300, the optical correction processing is performed on the image obtained in step S502, and in a case where the optical correction processing has already been performed on the target image by the imaging apparatus 300, the optical correction processing is performed on the image obtained in step S504. By the optical correction processing in step S505, an image in which image quality degradation caused by an optical characteristic has been eliminated may be obtained, or an image in which image quality degradation has been reduced to an extent that the image quality degradation does not become excessive may be obtained.

In step S506, the adjustment unit 313 performs the same gamma conversion as the gamma conversion performed by the imaging apparatus 300 on the basis of the gamma conversion information associated with the target image. As a result, it is possible to obtain an image obtained by reproducing an image obtained by the imaging apparatus 300 (the imaging apparatus 300 in a state where the optical correction processing performed by the optical correction unit 303 is changed).

Note that since the gamma conversion is performed after the optical correction processing is performed in the imaging apparatus 300, the inverse conversion (step S502) of the gamma conversion and the gamma conversion (step S506) are performed in the optical correction adjustment apparatus 311, but the present invention is not limited thereto. For example, in a case where the gamma conversion is performed before the optical correction processing is performed in the imaging apparatus as in the first embodiment, steps S502 and S506 are unnecessary. Since the gamma characteristic varies depending on the imaging apparatus, it is preferable to use the gamma conversion information described above in steps S502 and S506. However, in a case where the gamma conversion to be performed by the imaging apparatus is determined in advance, predetermined inverse conversion and gamma conversion may be performed in steps S502 and S506 without using the gamma conversion information.

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present invention are also included in the present invention. The present invention also includes other configurations obtained by suitably combining various features of the embodiment.

According to the present invention, it is possible to perform suitable optical correction processing on a moving image regardless of whether or not the optical correction processing has already been performed.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2024-056439, filed on Mar. 29, 2024, which is hereby incorporated by reference herein in its entirety.

What is claimed is:

1. An image processing apparatus comprising:
a processor; and
a memory storing a program which, when executed by the processor, causes the image processing apparatus to
execute first acquisition processing of acquiring optical characteristic information regarding an optical characteristic of a lens,
execute second acquisition processing of acquiring a moving image including images of a plurality of frames acquired via the lens,
execute first processing of performing first image processing on an image of each frame of the moving image on a basis of the optical characteristic information, and
execute output processing of outputting an image after the first image processing, the optical characteristic information corresponding to the image, and first image processing information regarding the first image processing corresponding to the image in association with each other.

2. The image processing apparatus according to claim 1, wherein
in the first processing, a parameter of the first image processing for each frame is determined such that a change in the parameter of the first image processing between frames of the moving image is limited.

3. The image processing apparatus according to claim 2, wherein
in the first processing, the parameter is determined such that the parameter changes with a predetermined time constant.

4. The image processing apparatus according to claim 2, wherein
in the first processing, the parameter is determined such that a change amount of the parameter between the frames of the moving image is limited to a threshold or less.

5. The image processing apparatus according to claim 1, wherein
the optical characteristic information indicates a characteristic of peripheral light falloff.

6. The image processing apparatus according to claim 1, wherein
the optical characteristic information indicates a characteristic of chromatic aberration of magnification.

7. The image processing apparatus according to claim 1, wherein
the optical characteristic information indicates a characteristic of distortion aberration.

8. The image processing apparatus according to claim 1, wherein
the first image processing information indicates a parameter of the first image processing.

9. The image processing apparatus according to claim 1, wherein
the program, when executed by the processor, further causes the image processing apparatus to execute second processing of performing second image processing on an image of each frame of the moving image after the first image processing, wherein
in the output processing, an image after the first image processing and the second image processing, the optical characteristic information corresponding to the image, the first image processing information corresponding to the image, and second image processing information regarding the second image processing corresponding to the image are outputted in association with each other.

10. The image processing apparatus according to claim 9, wherein
the second image processing information indicates a gamma characteristic.

11. The image processing apparatus according to claim 1, wherein
in the output processing, an image after the first image processing, the optical characteristic information corresponding to the image, and the first image processing information corresponding to the image are recorded in association with each other.

12. The image processing apparatus according to claim 1, wherein
in a case where first image processing is performed on the image of each frame of the moving image on the basis of the optical characteristic information in the first processing, in the output processing, an image on which first image processing is not performed and the optical characteristic information corresponding to the image are outputted in association with each other.

13. An image processing apparatus comprising:
a processor; and
a memory storing a program which, when executed by the processor, causes the image processing apparatus to
execute acquisition processing of acquiring, for each frame of a moving image, an image after first image processing based on an optical characteristic of a lens, optical characteristic information regarding the optical characteristic, and first image processing information regarding the first image processing, and
execute reprocessing processing of cancelling the first image processing performed on the image on a basis of the first image processing information, and performing second image processing on an image after the cancellation on a basis of the optical characteristic information.

14. The image processing apparatus according to claim 13, wherein
in a case where the image acquired by the acquisition processing is an image obtained by performing third image processing after performing the first image processing based on the optical characteristic, in the acquisition processing, third image processing information regarding the third image processing is further acquired, and
in the reprocessing processing, the first image processing performed on the image is cancelled after canceling the third image processing performed on the image.

15. An image processing method comprising:
acquiring optical characteristic information regarding an optical characteristic of a lens;
acquiring a moving image including images of a plurality of frames acquired via the lens;
performing image processing on an image of each frame of the moving image on a basis of the optical characteristic information; and
outputting an image after the image processing, the optical characteristic information corresponding to the image, and image processing information regarding the image processing corresponding to the image in association with each other.

16. An image processing method comprising:
acquiring, for each frame of a moving image, an image after first image processing based on an optical characteristic of a lens, optical characteristic information regarding the optical characteristic, and first image processing information regarding the first image processing; and
cancelling the first image processing performed on the image on a basis of the first image processing information, and perform second image processing on an image after the cancellation on a basis of the optical characteristic information.

17. A non-transitory computer readable medium that stores a program, wherein the program causes a computer to execute an image processing method comprising:
acquiring optical characteristic information regarding an optical characteristic of a lens;
acquiring a moving image including images of a plurality of frames acquired via the lens;
performing image processing on an image of each frame of the moving image on a basis of the optical characteristic information; and
outputting an image after the image processing, the optical characteristic information corresponding to the image, and image processing information regarding the image processing corresponding to the image in association with each other.

18. A non-transitory computer readable medium that stores a program, wherein the program causes a computer to execute an image processing method comprising:
acquiring, for each frame of a moving image, an image after first image processing based on an optical characteristic of a lens, optical characteristic information regarding the optical characteristic, and first image processing information regarding the first image processing; and
cancelling the first image processing performed on the image on a basis of the first image processing information, and perform second image processing on an image after the cancellation on a basis of the optical characteristic information.
